(19) United States
(12) Patent Application Publication
(10) Pub. No.: US 2026/0140232 A1
(43) Pub. Date: May 21, 2026

(54) SENSOR DEFLECTOR AND RELATED METHODS

(71) Applicant: Morton Industries LLC, Morton, IL (US)

(72) Inventor: Travis Kirkman, Dallas, TX (US)

(73) Assignee: Morton Industries LLC, Morton, IL (US)

(21) Appl. No.: 19/392,924

(22) Filed: Nov. 18, 2025

Related U.S. Application Data
(60) Provisional application No. 63/721,674, filed on Nov. 18, 2024.

(51) Int. Cl. G01S 7/481; B60R 11/00; G01S 7/521

(52) U.S. Cl. CPC G01S 7/4811; B60R 11/00; G01S 7/521; B60R 2011/004

(57) ABSTRACT

A sensor deflector is disclosed for preventing false alerts from vehicle parking sensors obstructed by after-market accessories such as grill guards or push bars. The deflector includes a main body shaped and sized to cover only the portion of an obstruction within the detection range of the sensor. Positioned at an angle between approximately 5 and 85 degrees, the main body redirects acoustic or light pulses away from the sensor so the pulses do not reflect back and trigger false alerts, while allowing the sensor to remain functional outside the deflected range. The sensor deflector may include an attachment tab or other mounting features for securing it to the obstructing accessory and may be formed from various materials suitable for automotive environments. Methods of deflecting sensor pulses, selectively controlling sensor coverage, and installing a sensor-compatible vehicle accessory using the sensor deflector are also disclosed.

### BACKGROUND OF THE INVENTION

### Field of the Invention

The present invention relates generally to a vehicle sensor deflector and related methods, and, more particularly, to a vehicle sensor deflector configured to prevent unwanted interference caused by after-market vehicle attachment accessories and methods for the same.

### Description of Related Art

Vehicle sensors or parking sensors are proximity sensors for road vehicles designed to alert the driver of obstacles while parking thereby reducing the risk of collisions and accidental damage. These systems utilize either electromagnetic or ultrasonic sensors. These systems feature ultrasonic proximity detectors to measure the distances to nearby objects via sensors located in the front and/or rear bumpers or visually minimized within adjacent grills or recesses. The sensors emit acoustic pulses or soundwaves, with a control unit measuring the return interval of each reflected signal and calculating object distances. The system in turns warns the driver with acoustic tones, the frequency indicating object distance, with faster tones indicating closer proximity and a continuous tone indicating a minimal pre-defined distance. Systems may also include visual aids, such as LED or LCD readouts to indicate object distance. A vehicle may include a vehicle pictogram on the car's infotainment screen, with a representation of the nearby objects as colored blocks. Rear sensors may be activated when reverse gear is selected and deactivated as soon as any other gear is selected. Front sensors may be activated manually and deactivated automatically when the vehicle reaches a pre-determined speed to avoid subsequent nuisance warnings. The ultrasonic systems relies on the reflection of sound waves.

The concept of ultrasonic parking sensors was first developed in the early 1980s by Nissan in Japan. Nissan was among the first car manufacturers to introduce ultrasonic sensors that used soundwaves to detect obstacles. These sensors worked by emitting high-frequency soundwaves from sensors mounted on the bumper of the car. The sound waves bounce off objects and return to the sensor, allowing the system to calculate the distance to the obstacle. By the late 1980s, companies like Bosch and Delphi began developing and testing ultrasonic parking sensors for commercial vehicles. The initial designs demonstrated significant promise for improving parking safety.

Nissan became the first car manufacturer to offer ultrasonic parking sensors in a production car with the release of the Nissan President. This model featured sensors integrated into the rear bumper. Other major manufacturers, including Mercedes-Benz, BMW, and Honda, began to integrate ultrasonic parking sensors into their luxury models. These early systems typically had both a visual display and an audible alert, helping drivers park more safely and easily. By the early 2000s, parking sensors became more commonly available across various vehicle segments beyond luxury lines. Manufacturers began to offer the technology as an option or standard feature in mainstream vehicles, including sedans, SUVs, and trucks.

The Mercedes-Benz Parktronic system is an exemplary measuring system using ultrasonic sensors to detect the distance to an obstacle in critical driving situations. The system assists the driver when parking and in maneuvering situations at speeds of less than 15 km/h. The sensors in the front and rear bumpers emit ultrasound signals which are reflected back by an obstacle in the detection range. The reflected ultrasound signals are received by the sensors and their travel time is measured. The Parktronic control module uses the travel time of the reflected signal to calculates the distance between the vehicle and obstacle and actuates the warning indicators. The distance between the vehicle and the obstacle is indicated to the driver visually and audibly. In the process the brightness of the warning indicators can be adapted to the brightness of the surroundings automatically or manually depending on the model series. The Parktronic system is activated when the ignition is switched on. The system is active even if it was switched off manually for the last journey. The Parktronic system can be switched on and off with a switch.

Today, parking sensors are found on most if not all vehicles. Still, the parking sensors have numerous limitations. For example, parking sensors are prone to limited range, poor performance in weather conditions, sensor obstruction, and false alerts. False alerts are especially common in vehicles, such as trucks or SUVs, with after-market vehicle attachment accessories, such as grill guards or push bars. These accessories often obstruct the parking sensors, resulting in a constant false red alert of an imminent collision. To date, the only viable solution is to deactivate the obstructed sensors, to the extent that the sensors can even be deactivated.

Therefore, there is a need for a sensor deflector configured to prevent unwanted interference caused by after-market vehicle attachment accessories. The sensor deflector embodying the principles of the invention is configured to deflect soundwaves, acoustic pulses, or electromagnetic pulses emitted from a vehicle parking sensor so as to prevent a false alert caused by a vehicle attachment accessory without diminishing overall sensor functionality.

### BRIEF SUMMARY OF THE INVENTION

A sensor deflector embodying the principles of the invention is configured to prevent false alerts caused by vehicle parking sensors being obstructed by aftermarket accessories such as grill guards or push bars. These accessories often interfere with parking sensors by reflecting emitted soundwaves back toward the sensor. The inventive sensor deflector addresses this problem by redirecting soundwaves at a specific angle so they do not return to the sensor, thereby maintaining accurate sensor function while reducing false alarms. The deflector typically consists of a main body with front and rear faces, whose dimensions and shape depend on the size and position of the obstruction relative to the sensor.

The inventive sensor deflector may be angled between 5 and 85 degrees relative to the sensor to achieve optimal deflection. It is often attached to the obstructing accessory using tabs, bolts, or other fastening means, and may be made from materials such as rust-proof metal, plastic, or other weather-resistant substances. In typical applications, the deflector is shaped to match portions of vertical members on grill or brush guards, ensuring only the obstructed region is covered while preserving the rest of the sensor's detection range.

The invention also encompasses methods for deflecting and managing soundwaves from vehicle sensors. These methods include installing the deflector on the obstructing accessory, positioning it to selectively deflect portions of the emitted soundwaves, and ensuring that only the obstructed waves are redirected. This approach preserves the sensor's ability to detect real obstacles while preventing interference from accessories. Furthermore, the deflector design can be applied to other sensor technologies, such as LiDAR systems, that rely on similar reflective principles.

### BRIEF DESCRIPTION OF THE DRAWINGS

FIG. 1 is a perspective view of a sensor deflector embodying the principles of the invention;

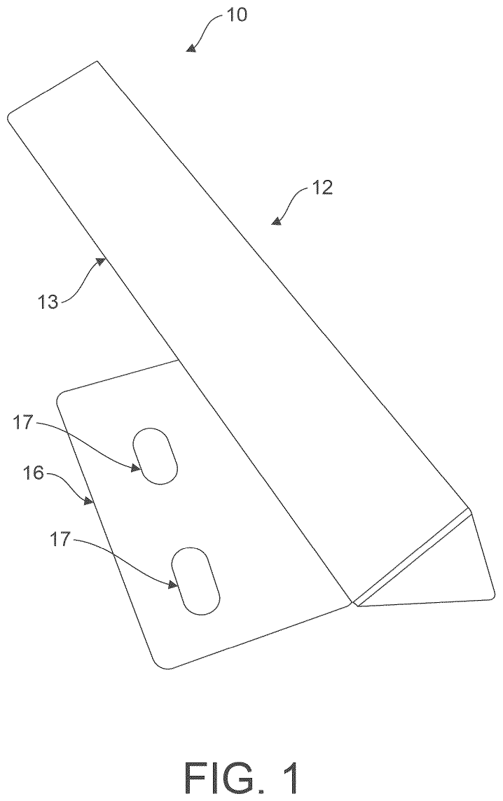

FIG. 2 is a perspective view of the front face of a sensor deflector embodying the principles of the invention;

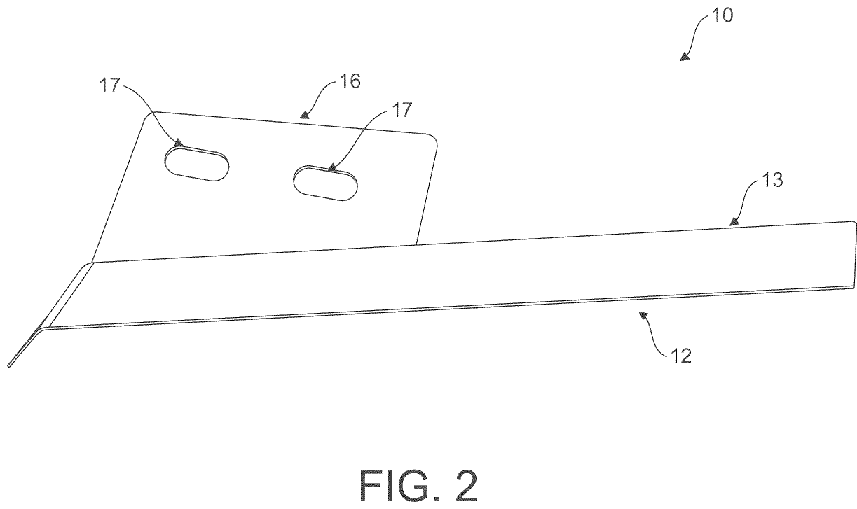

FIG. 3 is a perspective view of the rear face of a sensor deflector embodying the principles of the invention;

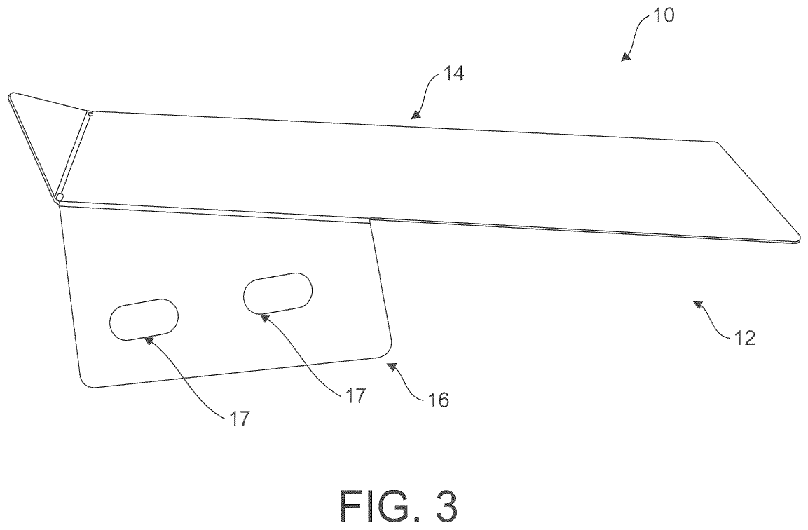

FIG. 4 is a perspective view of two sensor deflectors unattached to a vehicle attachment accessory;

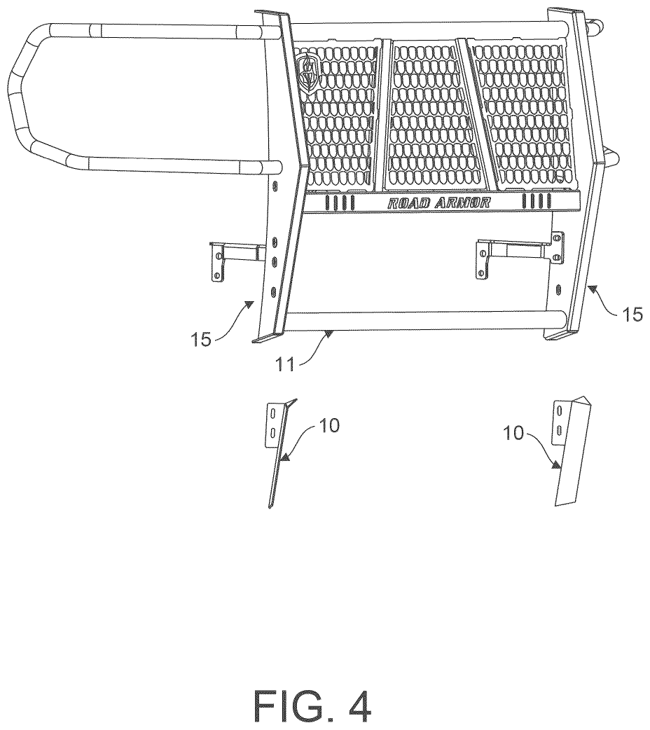

FIG. 5 is a frontal view of two sensor deflectors attached to a vehicle attachment accessory; and

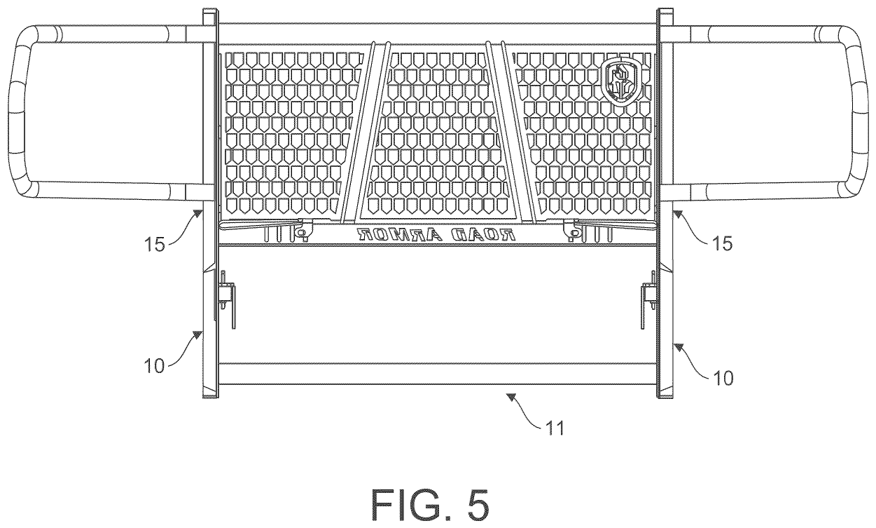

FIG. 6 is a side profile view of a sensor deflector attached to a vehicle attachment accessory.

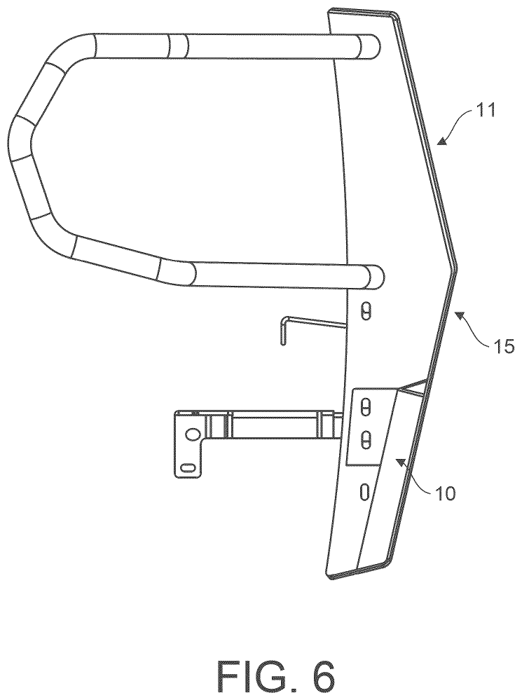

### DETAILED DESCRIPTION OF THE INVENTION

To promote an understanding of the principles of the present disclosure, reference will now be made to the embodiments illustrated in the drawings, which are described herein. The embodiments disclosed herein are not intended to be exhaustive or to limit the scope of the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

A sensor deflector (10) embodying the principles of the invention is configured to deflect soundwaves emitted from an obstructed vehicle parking sensor. Popular after-market vehicle attachment accessories (11), such as grill guards or push bars, often obstruct vehicle parking sensors, resulting in false alerts. By deflecting the soundwaves from an obstructed sensor at a specific angle, the sensor deflector (10) prevents the soundwave from reflecting or bouncing back to the sensor. The result is a reduction in unwanted interference from the attachment accessory (11) without diminishing sensor functionality.

A sensor deflector (10) embodying the principles of the invention may generally comprise a main body (12) with a front face (13) and a rear face (14). The shape or dimensions of the main body (12) may be a function of the shape of the obstruction (11), the positioning, i.e., distance, of the obstruction (11) from the sensor, and the range of the sensor. For example, the further away the obstruction (11) is from the sensor, the larger the main body (12) may need to be, as the soundwaves propagate outward with increasing scope. Conversely, the closer the obstruction (11) is from the sensor, the smaller the main body (12) may need to be. The main body (12) of the sensor deflector (10) may cover the portion of the obstruction (11) that is within the sensor range. The main body (12) may have sufficient length and width to cover the portion of the obstruction (11) that is within the sensor range. In general, the main body (12) may have a width of half an inch or greater and a height of half an inch or greater. The main body (12) may be flat.

Most vehicle attachment accessories (11), such as grill guard, comprise two vertical members (15) that may obstruct parking sensors when installed on a vehicle. As a result, most sensor deflectors (10) may be shaped according to the dimensions of the two vertical members (15), i.e., the obstructions (11). That is to say that most sensor deflectors (10) may be elongated in shape to run along the portion of a vertical member (15) that is within the range of the sensor. By shaping the sensor deflector (10) to match only the portion of the obstruction (11) that is within the range of the sensor, the sensor deflector (10) may deflect only the necessary soundwaves so as not to trigger the sensor while still maintaining the overall functionality of the sensor as a whole.

The main body (12) may be positioned at an angle not parallel to the sensing axis of the sensor. The main body (12) may be configured to deflect a soundwave emitted from a sensor at an angle of more than 5 degrees and less than 85 degrees. This range adequately deflects emitted soundwaves so that the soundwave does not return to the sensor. This prevents the obstruction (11) from causing a false alert. Because the sensor deflector (10) only deflects a portion of the range of the sensor, the sensor is still fully functional outside of the deflected range.

A sensor deflector (10) embodying the principles of the invention may further comprise an attachment tab (16). The attachment tab (16) may be configured to attach the sensor deflector (10) to the obstruction (11). The attachment tab (16) may comprise a slot (17) or a pair of slots configured to bolt to the obstruction (11). The attachment tab (16) may be coupled to the main body (12) at an angle that promotes the necessary deflection of soundwaves to not trigger a false alert. In some embodiments, the main body (12) may be bolted, welded, or glued to the obstruction (11) at an angle that promotes the necessary deflection of soundwaves. Other conventional means of attaching the main body (12) to the obstruction (11) not explicitly listed herein are contemplated by this disclosure.

A sensor deflector (10) embodying the principles of the invention may be made of various materials including metals, plastics, wood, or paper. The preferred material is dependent on the specific application. In a preferred embodiment, the sensor deflector (10) may be made out of a rust-proof metal so as to be weather-resistant. The sensor deflector (10) may further be coated or painted so as to match the attachment accessory (11).

An exemplary sensor deflector (10) will now be described. An exemplary sensor deflector (10) may be compatible with a brush guard (11) designed for a half-ton truck, such as a Dodge Ram or Ford F-150. Such a brush guard (11) may comprise two vertical members (15) on either side of the grill that may attach to the truck. The vertical members (15) may be so positioned so as to be in the range of the front parking sensors thereby triggering the front parking sensors of the truck. An exemplary sensor deflector (10) may cover the portion of the brush guard (11) that is within the range of the front parking sensor. An exemplary sensor deflector (10) is shown in the figures. An exemplary sensor deflector (10) may be flat with a main body (12) and two faces (13 and 14). The faces (13 and 14) of the main body (12) may be angled so at to deflect the soundwaves emitted from the parking sensor. The faces (13 and 14) of the main body (12) may not be parallel to the parking sensor. An exemplary sensor deflector (10) may be positioned at an angle ranging from 5 to 85 degrees to promote proper deflection. An exemplary sensor deflector (10) may further comprise an attachment tab (16). An attachment tab (16) may attach the sensor deflector (10) to the brush guard (11). The drawings further disclose an exemplary sensor deflector (10) attached to the vertical members (15) of a grill guard (11).

A method of deflecting acoustic pulses emitted from a parking sensor around an obstruction is further disclosed herein. The method may comprise the following steps: attaching an after-market vehicle attachment accessory on a vehicle; attaching a sensor deflector to the attachment accessory; wherein the vehicle has at least one parking sensor; wherein the attachment accessory comprises at least one member that is within the range of the parking sensor thereby triggering the parking sensor; wherein the sensor deflector deflects the acoustic pulses emitted from the parking sensor at an angle that prevents the soundwave from bouncing back to the parking sensor thereby preventing the attachment accessory from triggering the parking sensor.

A method of selectively deflecting soundwaves is further disclosed herein. The method may comprise the following steps: positioning a sensor deflector over an obstruction; deflecting a portion of soundwaves emitted from a sensor; not deflecting another portion of soundwaves emitted from a sensor; wherein the deflected soundwaves do not reflect onto the sensor; wherein the remaining soundwaves do reflect onto the sensor if there is an obstacle; wherein the deflected soundwaves would trigger a false alert if reflected onto the sensor.

A method of installing a sensor compatible attachment accessory to a vehicle is further disclosed herein. The method may comprise the following steps: installing an attachment accessory to the front of a vehicle; installing a sensor deflector over the portion of the attachment accessory that is within the range of a parking sensor; wherein the sensor deflector is positioned at an angle to deflect a portion of the soundwaves emitted from the parking sensor; wherein the deflected soundwaves do not reflect off the attachment accessory and do not trigger the parking sensor; wherein the remaining soundwaves are not deflected by the sensor deflector; wherein the remaining soundwaves reflect off obstacles to trigger the parking sensor.

The invention may also be used with other vehicle motion sensors that utilize light or electromagnetic pulses, including, but not limited to, Time of Flight (ToF) LiDAR, Frequency-Modulated Continuous Wave (FMCW) LiDAR, Scanning LiDAR (mechanical), and Flash LiDAR, as well as other sensors based on analogous principles.

1. A sensor deflector configured to deflect sound or light waves emitted from an obstructed vehicle sensor, comprising:
a main body with a planar front face and a planar rear face; and
an attachment tab configured to attach the rear face of the main body to an obstruction;
wherein the main body is positioned at an oblique angle relative to a sensing axis of the sensor;
wherein the main body is configured to cover a portion of the obstruction that is within a detection range of the sensor;
wherein the sound or light waves strike the front face of the main body and are deflected away from the sensor to not trigger a false alert; and
wherein the main body is configured to maintain the functionality of the sensor to detect other hazards beyond the obstruction.

2. The sensor deflector of claim 1, wherein the main body is predominantly flat.

3. The sensor deflector of claim 1, wherein the main body has a width of at least 0.5 inches and a height of at least 0.5 inches.

4. The sensor deflector of claim 1, wherein the dimensions of the main body are a determined by the geometry of the obstruction, the distance between the obstruction and the sensor, and the detection range of the sensor.

5. The sensor deflector of claim 1, wherein the main body is dimensioned to cover the portion of the obstruction located within the detection range of the sensor.

6. The sensor deflector of claim 1, wherein the obstruction comprises a vertical member of a vehicle attachment accessory.

7. The sensor deflector of claim 1, wherein the main body is vertically elongated to correspond in shape to a vertical member of a vehicle attachment accessory.

8. The sensor deflector of claim 1, wherein the main body reduces unwanted interference from the obstruction without diminishing the functionality of the sensor to detect other hazards.

9. The sensor deflector of claim 1, wherein the front face of the main body is positioned to deflect sound or light waves emitted from the sensor at an angle between 5 and 85 degrees relative to the sensing axis.

10. The sensor deflector of claim 1, wherein the attachment tab comprises one or more slots configured to couple the main body to the obstruction.

11. The sensor deflector of claim 1, wherein the attachment tab is coupled to the main body at a predetermined angle to promote the deflection of sound or light waves to not trigger a false alert.

12. The sensor deflector of claim 1, wherein the sensor deflector is further configured to deflect electromagnetic pulses emitted from a LiDAR based vehicle sensor at an angle to not trigger a false alert caused by the obstruction.

13. A method of deflecting acoustic or light pulses emitted from a vehicle sensor around an obstruction, comprising the steps of:
attaching an attachment accessory on a vehicle;
identifying a portion of the attachment accessory located within a detection field of the sensor; and
attaching a sensor deflector to said portion of the attachment accessory at an oblique angle relative to a sensing axis of the sensor to prevent the acoustic or light pulses from bouncing back to the sensor;
wherein the sensor deflector prevents the attachment accessory from triggering the sensor.

14. The method of claim 13, wherein the sensor deflector is positioned at an angle between 5 and 85 degrees relative to the sensing axis of the sensor.

15. The method of claim 13, wherein the light pulses are emitted from a LiDAR sensor.

16. A method of selectively redirecting sound or light pulses emitted from a vehicle sensor, comprising the steps of:
positioning a sensor deflector over an obstruction;
redirecting a first portion of the sound or light pulses directed at the obstruction; and
not redirecting a second portion of the sound or light pulses not directed at the obstruction;
wherein the first portion of the sound or light pulses do not reflect back onto the sensor;
wherein the second portion of the sound or light pulses do reflect back onto the sensor if there is an obstacle; and
wherein the first portion of the sound or light pulses would trigger a false alert if reflected back onto the sensor.

17. The method of claim 16, further comprising the step of positioning the sensor deflector at an angle between 5 and 85 degrees relative to a sensing axis of the sensor to promote proper redirection.

18. The method of claim 16, wherein the sensor deflector is configured to redirect electromagnetic pulses emitted from a LiDAR sensor.

19. A method of installing a sensor-compatible attachment accessory to a vehicle, comprising the steps of:
installing an attachment accessory to the front of a vehicle;
installing a sensor deflector over a portion of the attachment accessory that is within the detection range of a sensor; and
positioning the sensor deflector at an angle to deflect a first portion of the soundwaves or light pulses emitted from the sensor;
wherein the first portion of the soundwaves or light pulses do not reflect back off the attachment accessory to not trigger the sensor;
wherein a second portion of the soundwaves or light pulses are not deflected by the sensor deflector and
reflect back off obstacles to trigger the sensor.

20. The method of claim 19, wherein the sensor deflector is positioned at an angle ranging from 5 to 85 degrees relative to a sensing axis of the sensor.
